(19) United States
(12) Patent Application Publication
(10) Pub. No.: US 2019/0007150 A1
(43) Pub. Date: Jan. 3, 2019

(54) METHOD FOR OPTIMISING AN ALLOCATION OF CHANNELS FOR BROADCASTING A MULTIMEDIA STREAM

(71) Applicant: EUTELSAT S A, Paris (FR)

(72) Inventors: Antonio ARCIDIACONO, Paris (FR); Daniele Vito FINOCCHIARO, Paris (FR)

(21) Appl. No.: 15/576,440

(22) PCT Filed: May 25, 2016
(86) PCT No.: PCT/FR2016/051231

§ 371 Date: Nov. 22, 2017

(30) Foreign Application Priority Data
May 27, 2015 (FR) 1554762

(51) Int. Cl. H04H 20/42; H04H 20/24; H04N 21/61; H04N 21/643

(52) U.S. Cl. CPC H04H 20/423; H04H 20/24; H04N 21/64322; H04N 21/6143; H04N 21/6112

(57) ABSTRACT

A method for optimising an allocation of channels for broadcasting at least one first multimedia data stream, wherein a piloting component pilots the allocation among at least one first broadcasting channel delivering the first stream by a satellite broadcasting system and a second broadcasting channel delivering the first stream by a terrestrial data network, the method including: a determination of an allocation parameter including a calculation of an audience value, performed by an audience collector component; and a selection of at least one broadcasting channel as a function of the allocation parameter for the broadcasting of at least the first stream.

### FIELD

The field of the invention relates to the methods aiming at choosing a broadcasting path of a multimedia content between a content provider and a population of final users each having a terminal. The field of the invention aims at the methods enabling the best path to be defined as a function of given requirements without causing information losses, by minimising the broadcasting cost, and offering the best quality to the final user. In particular, the invention relates to the “live” or streaming content broadcasting of “video” type files, broadcast by channels and likely to overload a CDN type terrestrial data network when many user requests are concomitant.

### STATE OF THE ART

Currently, multimedia content providers, and more particularly video content providers such as a television channel, cope with an increased demand for access to their content. Indeed, in recent years, several causes have brought about the emergence of an increasingly diversified channel offer. First, the digital packages have increased the video content offer, and then international channels and thematic channels (sports, travel, youth, etc.) have found large echoes in the home. Finally, Internet channels and IP broadcast protocols have enabled an even richer offer to complete a first traditional television offer. The packages provided by the operators have significantly increased in order to provide users with a full offer when the latter were provided with a suitable access means. A suitable access means can currently be a combined offer between a satellite package and a package available by a terrestrial network via the Internet, both packages forming a single catalogue of a provider.

Depending on the locations, events, programming and type of access means of the users, the catalogue of accessible channels can vary from home to home.

One problem, resulting from this offer and access request increase to a multimedia “live” content increasingly diversified, is that the transmission of a live file on the Internet network occupies a significant transmission pass band. CDN networks, meaning “Content Distribution Network”, have undergone in recent years a large expansion and a significant deployment, because of the occupation decrease of the network core they generated. However, there remains a major problem in broadcasting content by the Internet which is the management of broadcast from the CDN presence point to the user terminal to be performed. The network can meet saturation during large events or when an audience peak occurs because the content has to be replicated in several copies in order to be broadcast in each user terminal. The saturation can cause inconveniences upon viewing a content such as cuts, for example, or a decrease in the transmitted content quality. Indeed, Internet streaming protocols, such as “HLS”, automatically lower the video quality, by increasing the compression rate, to adapt to the available bandwidth for the final user.

This band occupation is all the stronger as a content is viewed a large number of times. A bandwidth reservation commits a cost in terms of allocated rate reservation occupation and it has therefore also a financial and structural cost.

This problem is not found in broadcasting content by satellite. Indeed, a same content broadcast by a given channel emitted by a satellite is received as many times as desired by a set of users without congesting the bandwidth of a neighbour. The broadcast cost is unique and does not depend on the number of users but only on the allocated bandwidth passing through a transponder of the satellite. The cost is thus fixed regardless of whether the content is viewed by a single user or by a great number of users.

One problem with the satellite content broadcast is that it is dimensioned for a given request at a given instant. Further, its limited size and the satellite payload can only take a limited number of channels into account. The number of channels that can be taken into account depends on the number of transponders, the bandwidth of each transponder and the coding applied to the transmitted media which comprises a more or less high rate. Finally, the satellite broadcast cost is justified only if a channel is seen by a significant number of users; on the contrary, the terrestrial “unicast” broadcast is less expensive.

Finally, currently, the video content broadcast emitted via streaming according to an IP protocol becomes increasingly normalised and widespread in the world. Hence, there is a desire from content providers to broadcast their contents only by the IP protocol. The latter is managed by nature by the Internet network but also for some years by the user receiver pieces of equipment receiving an IP stream via a satellite. In the case of satellite broadcast, the content can be transmitted already in IP format by satellite, or re-encoded by the receiver of the users.

There remains an unsolved problem which is the overload of a CDN terrestrial network when audience peaks occur on some channels given the user demand. This overload can cause a decrease in the service quality for the user, and a significant increase in the broadcast cost for the broadcaster.

A contrario, some channels broadcast by satellite can suffer a low audience whereas the broadcast cost of this content is fixed. Because of the multiplicity of channels and broadcast content, a static bandwidth allocation to different channels cannot bring about a satisfactory solution.

### SUMMARY OF THE INVENTION

The invention enables the abovementioned drawbacks to be solved.

The invention aims at providing an automatic solution to avoid overload of the terrestrial network and optimise broadcast costs, while ensuring the best quality possible for the users.

One object of the invention relates to a method for optimising an allocation of broadcasting channels of at least a first multimedia data stream delivered by at least a first content source. A piloting component pilots the allocation of a broadcasting channel among at least:
a first broadcasting channel delivering a first data stream by means of a satellite broadcasting system to at least a first user reception system, said at least first user reception system comprising first transmission means of the first data stream to at least a first user terminal;
a second broadcasting channel delivering the first data stream by means of a terrestrial data network to at least a second user reception system, said at least second user reception system comprising second transmission means of the first data stream to at least the first user terminal,

said method comprising:
determining an allocation parameter comprising calculating an audience value of at least one number of first data streams delivered to a first set of terminals by at least one broadcasting channel, said calculation being performed by means of at least one audience collector component;
selecting at least one broadcasting channel by the piloting component as a function of the allocation parameter for broadcasting at least the first data stream to at least the first user terminal.

One advantage of the invention is to mitigate the pass band occupied on the terrestrial network by the use of a satellite pass band as a function of the collected and measured audience of one or more media which are broadcast or to be broadcast.

According to one embodiment, the audience collector component collects audience data of a second set of terminals of the first set of terminals by means of a back link between at least the first user reception system and a terrestrial base station passing through at least one satellite.

According to one embodiment, the audience collector component comprises a data server connected to the terrestrial data network and collects audience data of a third set of terminals of the first set of terminals by means of a terrestrial back link.

According to one embodiment, each terminal of the second set and the third set of term in-laws receives the first stream by the first transmission means or the second transmission means.

According to one embodiment, the audience collector component centralises the audience data of the second and third sets of terminals.

According to one embodiment, the piloting component comprises a first configuration enabling at least one event to be defined at a given date and having a predefined duration during which the allocation parameter is modified so as to select a predefined broadcasting channel to at least the first user terminal for transmitting a data stream.

According to one embodiment, the piloting component comprises a second configuration enabling a set of time slots of the calendar during which the allocation parameter is modified to be defined so as to select a predefined broadcasting channel to at least the first user terminal for transmitting a data stream.

According to one embodiment, at least one given terminal generates an instruction for selecting a single broadcasting channel when a first stream is accessible through both transmission channels, said instruction being transmitted to the first transmission means or to the second transmission means so as to end the transmission of the first stream to said at least one terminal.

It is noted that “to end the transmission” in the satellite case impacts the “local” link between the antenna and the terminal. In the terrestrial case, on the contrary, the stream is stopped upstream for example in the case of a CDN network.

According to one embodiment, the transmission means, receiving a selecting instruction, transmit said selecting instruction to the piloting component so as to carry out a selection of at least one broadcasting channel as a function of the selecting instruction to ensure a single broadcasting of at least the first data stream to at least the first user terminal.

According to one embodiment, the first data source comprises the piloting component.

According to one embodiment, a first data source and a second data source each deliver the first multimedia data stream to the first broadcasting channel and respectively to the second broadcasting channel, said selection of the channel being carried out by a piloting component connected to said two data sources.

According to one embodiment, a configuration of the width of the pass band of the first broadcasting channel is determined as a function of the allocation parameter.

According to one embodiment, the satellite broadcast system comprises at least one ground station comprising at least one antenna for emitting signals to the satellite, the piloting component allocating a set of data streams to a plurality of encoding computers as a function of at least one allocation parameter, each encoding computer:
encoding the delivered streams selected by the piloting component in frames IP to a multiplexer;
allocating a compression quality to each data stream delivered as a function of at least one allocation parameter,

said ground station comprising a multiplexer delivering a set of data to be modulated and to be emitted by the antenna to the satellite.

According to one embodiment, the satellite comprises a second multiplexer and a plurality of transponders each forming a transmission channel ensuring a given pass band, each data stream selected by the piloting component being automatically distributed in at least one transponder as a function of the allocation parameter.

According to one embodiment, the piloting component further automatically determines the compression quality of the first stream as a function of the allocation parameter.

According to one embodiment, the first user reception system comprises:
an antenna for receiving a signal of a first frequency band;
a signal amplifier for amplifying the received signal;
a component enabling the received signal to be transposed in a second frequency band;
a modem enabling a received or emitted signal to be modulated and demodulated;
a signal converter enabling a digital data stream to be delivered.

According to one embodiment, the first user reception system further comprises:
an antenna for emitting a signal of a third frequency band to a satellite.

According to one embodiment:
the terrestrial data network comprises a CDN network for broadcasting multimedia content;
the second user reception system comprises a modem using an ADSL or fibre technology connected to the data network;
the second transmission means comprise a WIFI interface.

According to one embodiment,
the multimedia content comprises a video stream and/or an audio and/or data stream;
the multimedia content is delivered in a continuous stream ensuring viewing on the user terminal continuously;
the frames conveying the multimedia content in the first and/or the second broadcasting channel are IP frames.

The satellite signal can also be ensured by a Transport Stream DVB protocol and not an IP stream, with a conversion by the DEMOD.

According to one embodiment, the user terminal is:
a smartphone and/or;
a touch tablet and/or;
a pc;
a television set.

Another object of the invention relates to a user terminal enabling viewing of a multimedia content, characterised in that it comprises:
a first interface for receiving data from first transmission means delivering a first data stream passing beforehand through a satellite and broadcast to a set of terminals;
a second interface for receiving data from second transmission means delivering the first data stream passing through a terrestrial network, upon request from the terminal, said terminal comprising a computer:
   determining an availability of the first stream on both interfaces;
   generating a selecting instruction to the second transmission means to end the transmission of the first stream to the user terminal;
   selecting the first interface to receive the first data stream.

### BRIEF DESCRIPTION OF THE FIGURES

Further characteristics and advantages of the invention will appear upon reading the detailed description that follows, in reference to the appended figures, which illustrate:

FIG. 1: an overview of the different broadcast paths for video contents conveyed to a user terminal;

FIGS. 2A and 2B: switching from path to path of a video stream as a function of audience data;

FIG. 3: a scheme giving details of the allocation of video streams by a transmitter to a satellite for broadcasting said streams.

### DESCRIPTION

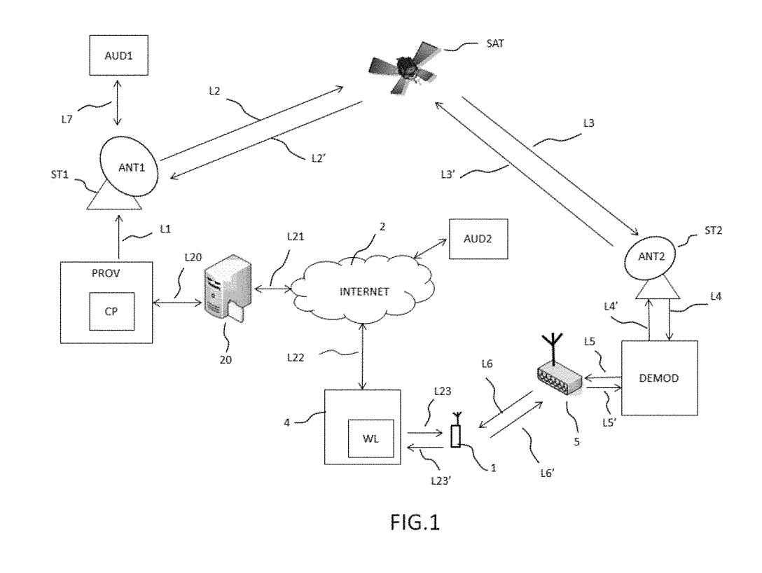

FIG. 1 represents a system enabling the method according to the invention to be implemented.

### Content Provider

In this embodiment, a content provider, noted PROV, enables one or more streams to be broadcast in at least two broadcasting channels CH₁, CH₂.

In this embodiment, the content provider PROV comprises a piloting component, noted CP, enabling a video stream to be broadcast or not in zero, one or more broadcasting channels.

According to FIG. 1, a first broadcasting channel comprises links L1, L2, L3. It corresponds to broadcasting contents by satellite SAT. A second broadcasting channel comprises links L20, L21, L22. It corresponds to broadcasting contents via an Internet network 2.

According to other modes, the piloting component CP can control stream broadcast from different content providers PROV which can for example be located in different geographical locations.

When the content to be broadcast is stored elsewhere than in the content provider PROV or in a delegate content provider as a server of a CDN network, the piloting component CP can transmit an instruction through the CDN network allowing or inhibiting broadcasting a video stream by the concerned server(s).

The streams emitted by the content provider PROV or by a delegate server in the second broadcasting channels via the Internet network 2 are encapsulated in IP frames. The frames are continuously emitted to ensure a streaming service. Each content has to be replicated in a dedicated stream for each user requesting it (“unicast” emission) from the server closest to the CDN network.

### User Terminal

A user wishes to access and view a multimedia stream corresponding for example to a video stream of a given channel. The terminal 1 he/she uses comprises an interface enabling him/her to select the desired channel for example from an integrated interface or a remote control. The terminal 1 can be a smartphone, a tablet, a computer or even a television set.

According to the configuration being employed, the user terminal 1 can be connected to one or more user reception system(s).

According to one embodiment, the terminal comprises a function for detecting the number of available streams, an interface enabling the stream source to be chosen according to the available broadcasting channel. Stream detection is performed according to an alternative embodiment by an analysis of the signalling frames for example IP frames. When a single stream is available, the terminal does not generate any interface window enabling the stream source to be chosen. When the function of the terminal detects streams from different sources, an interface can be generated to query the user. According to another embodiment, a default available stream choice is predefined, for example the best quality stream which is usually the one coming from the satellite.

### First User Reception System

By way of example, in FIG. 1, a first user reception system {ST2, ANT2, DEMOD, 5} comprising a satellite antenna ANT2 associated with a local reception device enabling the signal received by the antenna ANT2 to be demodulated is represented. One example of such a demodulator is represented in FIG. 1 by the DEMOD device connected to the reception antenna ANT2 through a link L4.

Further, the first user reception system comprises a local access piece of equipment 5 connected to the local reception device ANT2, DEMOD by a wire or wireless access path L5. The local access piece of equipment 5 can be, for example, a local wireless router. The wireless router 5 is, for example, configured to locally emit along a channel L6 the multimedia stream to one or more terminal(s).

In the case of a user reception system ST2 intended to receive signals from a satellite comprising at least one multimedia stream, a back link L6′, L5′, L4′, L3′, L2′ can be provided. The back link enables for example an interactivity to be offered when viewing a stream as a vote or a choice of a user to be taken into account. This back link can be advantageously used according to the method of the invention to collect viewing data of a user.

When a user selects a given stream to be viewed, an indicator identifying the selected stream is generated and is forwarded to an audience collector component. According to one embodiment, the satellite comprises a back link enabling data from a plurality of users comprising the viewed stream indicator to be transmitted.

According to another embodiment, the audience data can be forwarded to an audience collector component via the Internet network 2.

To obtain reliable audience values, it is not necessary to receive data from all users, but only from a subset.

### Second User Reception System

According to one embodiment, a second user reception system 4 is connected to the Internet network through a link L22 which can be a fibre or a feeder or a copper pair. The second user reception system 4 comprises a local reception device, such as a modem or an ADSL box, noted 4 in FIG. 1. In this configuration, the local reception device 4 comprises transmission means WL enabling the multimedia stream to be broadcast by wireless pathway L23 or by a wire path.

Depending on cases, a user has a terminal which is:
either associated to a first reception system by satellite,
or associated to a second reception system by a terrestrial path,
or associated to two reception systems one of which is a reception system by a satellite and the other is a reception system by a terrestrial path, as is represented in FIG. 1.

When a stream is received through the second user reception system 4, the user via its terminal 1 is also capable of selecting data and generating back orders such as votes, opinions or specific actions when the stream is broadcast. Under this configuration, wherein the second user reception system 4 is connected to the Internet network, the network is already configured to enable data exchanges in the bidirectional channel. The method of the invention thus comprises an audience collection according to the stream selected by the user which is emitted from the second user reception system 4 to an audience collector component AUD2 via the Internet network 2.

The invention is applicable to users having term in-laws connected to reception systems one of which is by satellite and the other by a terrestrial pathway. The invention is also applicable to users having a terminal connected to one of both reception systems, namely only benefiting from one access being either by satellite, or terrestrial. In the case where a terminal is only connected to one reception system, the method will not enable the reception bandwidth to be optimised by allocating channels of one path to another path (for example, by allocating channels of the terrestrial bandwidth on the satellite bandwidth). On the other hand, in this configuration, the method according to the invention enables the choice of channels to be optimised via satellite when the terminal is connected to a satellite pathway via an adapted reception system.

### Functions Ensured by Each User Reception System

According to one embodiment, each user reception system 4 or {ST2, ANT2, DEMOD, 5} is configured to receive IP frames encapsulating video frames. Further, the user reception systems are configured to receive unicast frames, that is a point-to-point network connection, or multicast frames, that is a multipoint connection.

When a stream is received by a multicast connection by a user reception system, said reception system can be configured to analyse the received IP frames so as to:
modify the multicast IP header in a unicast IP header; for example when different streams are conveyed to different terminals 1 by a user reception system; or
adding an IP header when the stream demodulated by the user reception system directly leads to a MPEG2 frame; or
directly route a multicast IP stream to one or more terminals; or
decode an audio or video multimedia stream in a given format and re-encode it in another suitable format for the terminal and optionally re-encode it in an IP frame or;
encrypt a stream or decrypt or re-encrypt a stream according to two different encrypting protocols; for example when the purpose is to decrypt a CAS stream and encrypt it into DRM.

According to one embodiment, the first user reception system {ST2, ANT2, DEMOD, 5} can comprise a functionality aiming at indicating that a stream is no longer available via a satellite broadcast via the first broadcasting channel CH₁. An instruction can thereby be generated such that the terminal requests access to a unicast stream to a server of the Internet network of the second broadcasting channel CH₂. The stream is thereby emitted on demand via the Internet network 2.

This case can happen when a stream is little viewed, the audience drops, and the piloting component suspends stream emission by satellite.

According to a first alternative embodiment, an instruction can be emitted with optionally a link to the server(s) having this stream available to automatically trigger a request from the terminal to the second broadcast network. Thus for the user, viewing a stream suspended by the first broadcasting channel is automatically managed by the second broadcasting channel CH₂.

According to a second alternative embodiment, an instruction is generated by the piloting component directly to a server of the CDN network which manages stream emission in unicast mode to the second reception system 4 such that it is conveyed to a given terminal 1. In this alternative, the source changes but that is transparent for the terminal and thus for the user.

### Broadcasting Channels

A first broadcasting channel CH₁ comprises a satellite broadcast path in which a set of data streams is emitted by an antenna ANT1 to the satellite SAT. The connection is a multicast connection in which at least one content provider PROV broadcasts a content to a plurality of user reception systems. The set of streams is broadcast. It is the user reception system which sorts and selects the desired stream depending on a user instruction which could have been, for example, activated from his/her terminal. The content provider PROV can administer and manage a plurality of multimedia streams towards the satellite SAT by means of a multiplexer MUX1 receiving the data by different pathways L1 from the content provider. The data streams are emitted by the emission antenna ANT1 by following an uplink L2 to the satellite SAT. The satellite SAT comprises a plurality of transponders capable of processing the received signals by amplifying them, filtering, frequency transposing and reemitting the streams.

The satellite SAT broadcasts by a downlink L3 the multimedia streams to a plurality of user reception systems ANT2, DEMOD, 5 via satellite capable of demodulating the signals and processing the emitted data.

A second broadcasting channel CH₂ comprises a path which is computed within a terrestrial network comprising a plurality of pieces of equipment, such as the Internet network, between a server hosting the content and a user reception system. The broadcasting channel CH₂ is a point-to-point set unicast link between a server and a user reception system. A plurality of broadcasting channels CH₂ enables a plurality of streams to be delivered to a plurality of user reception systems.

### CDN Network

According to one embodiment, a CDN network is used for broadcasting video streams in the terrestrial network to optimise load distribution.

FIG. 1 represents, in this example, a server 20 enabling the content of the content provider PROV to be made accessible, via a link L20, to a set of users via the Internet network 2. According to an exemplary embodiment, the network used is a CDN network. A set of servers of the CDN network can thereby be deployed to relay the content to be broadcast or to host it. Each server comprising the content to be broadcast comprises a memory to store and broadcast the content.

According to one embodiment, a single reception piece of equipment can be used to perform functions of reception of the first and second user reception systems.

### Audience Collection

The method of the invention comprises a step enabling audience data to be collected. At a given moment, an audience is measured on a user panel viewing a given content corresponding to a data stream.

According to one embodiment, the audience data can comprise different pieces of information such as the last channel changes carried out by a user, the viewing duration of a channel, data from previous viewed channels.

When a user selects on its terminal 1 a given channel, such as a TV channel, an instruction is emitted to at least one reception system 4 and/or DEMOD. According to one embodiment, the instruction is sent to each reception system 4, DEMOD having a data connection with the terminal 1.

According to one embodiment, the instruction comprises a piece of information corresponding to the stream selected by the user. Further, the instruction can also comprise a piece of information about the default chosen reception system.

The user reception systems 4, {DEMOD, 5} can be therefore audience collector pieces of equipment, and they can collect data from all the terminals which are connected to said user reception systems 4, {DEMOD, 5}.

Depending on cases, the reception systems can convey and collect data with a single terminal or a plurality of terminals. In any case, according to one embodiment, the user reception systems can perform the audience collection function. The audience data can include the data of user profiles such as their age, centres of interests, etc.

According to one embodiment, only a set of terminals is counted in the audience measurement forming a panel of a wider set of terminals. According to another embodiment, all the terminals are counted.

According to one embodiment, at least one audience collector component AUD1, AUD2 collects a set of audience data from the network.

The audience data enable a network congesting state to be drawn up as a function of a user request. When the audience collector components communicate to the content provider(s) PROV the audience data, the method enables a selection of a broadcasting channel to be favoured as a function of a cost, a content quality to be ensured, the audience, their distribution, time slots or given events, etc. to be established.

If for example 20% of the terminals desire to access a same given stream and that these terminals have an access to this stream by a first broadcasting channel CH₁ and a second broadcasting channel CH₂, then the method of the invention comprises a selection step enabling the network load to be distributed or the stream broadcast to be switched to a broadcasting channel preferentially to another.

First Audience Collector Component AUD1 FIG. 1 represents a first audience collector component AUD1 connected, in this embodiment, to the antenna ANT1 intended to emit and receive data streams to the satellite SAT. The audience collector component AUD1 comprises means, such as a memory, to store all the audience pieces of information of each terminal 1 having emitted an audience piece of information from the user reception system, for example ANT2, DEMOD, 5.

The audience collector component AUD1 is connected to the antenna ANT2, for example, by means of a wireless connection L7 or a wire connection depending on the implementation of the invention.

In this example, each user reception system {ANT2, DEMOD} receiving data streams by the downlink L3 from the satellite SAT reemits by virtue of a back link L3′, L2′ the collected audience data depending on the user's choices. These audience data are received, by virtue of this back link, by the antenna ANT1 and are reemitted to the audience collector component AUD1.

According to another configuration, the back link can be ensured by the terrestrial connection when the user is connected to the Internet network via the link L22 for example, and even if the multimedia data stream is received by the satellite. The audience collection can thus be made independently of the reception system receiving the stream. The reverse case is also supported by the invention, that is when the stream comes from a terrestrial link via piece of the equipment 4, the audience collection or audience data transmission can be made either via the Internet link L22 or a satellite back link via the connections L4′, L3′ and L2′.

It is worth to note that in the case where the back link is ensured by satellite, that is by virtue of the connection L4′, L3′ and L2′, then the user reception system {DEMOD, ANT2} comprises a device enabling a signal to be modulated and amplified such that it is emitted to the satellite. Such a signal can also be modulated or coded by a spectrum spread method in an emission bandwidth.

### Second Audience Collector Component AUD2

FIG. 1 represents a second audience collector component AUD2 connected, in this embodiment, to the Internet network 2. In this example, no matter where the audience collector component AUD2 is connected as long as it is accessible through the network.

The audience collector component AUD2 advantageously comprises means, such as a memory, to store all the audience pieces of information depending on the stream viewed by each terminal 1.

In this example, each reception system 4 receiving data streams through the Internet network 2 forwards the collected audience data in the same network.

When a user reception system 4 or {ANT2, DEMOD, 5} is connected to a plurality of terminals 1, each reception system is configured to identify each terminal and assign to it a stream which has been selected by the user. In this case and according to one embodiment, each user reception system is configured to emit audience pieces of information depending on the streams viewed from each terminal.

Thus, according to one embodiment, a first part of the audience pieces of information is emitted to a first audience component AUD1 and a second part of the audience pieces of information is emitted to a second audience collector component AUD2.

According to one embodiment, a component centralising the audience data is configured to collect the audience data from both audience collector components AUD1, AUD2. According to an exemplary embodiment, the component centralising the audience data is one of both audience components AUD1 or AUD2.

According to another example, a single audience collector component AUD performs both audience data collecting functions of both broadcasting channels CH₁ and CH₂ made by both audience collector components AUD1 and AUD2.

The audience data can be collected among a sample of user terminals 1, as previously set forth, which is representative of a general audience of the viewed streams. The audience data advantageously comprise identifying the stream which is referred to by each terminal of the sample. Advantageously, the audience data comprise the access data of each terminal, that is the source data of the data stream which is referred to by the terminal 1.

Thus, a terminal 1 is capable of forwarding the piece of information from the stream source and the piece of information of the stream availability on different user reception systems. The stream source piece of information can be identified from signalling pieces of information of some frames decoded by the terminal.

For example, in the case of FIG. 1, the terminal 1 generates an indication that the data stream corresponding to a given channel comes from the reception system 4. It can also indicate the presence of the user reception system {5, DEMOD, ANT2} and possibly the stream availability by said user reception system 5, DEMOD, ANT2.

According to another embodiment, the user reception systems 4 and {5, DEMOD, ANT2} can themselves generate the audience piece of information when they select a stream to be emitted to the terminal 1. In this case, a user selects for example a channel. An instruction is generated and sent to the user reception systems 4 and {5, DEMOD, ANT2} which identifies the desired stream and which filters, decodes and transmits the desired multimedia stream to the terminal 1. In this embodiment, each user reception system 4 and/or {5, DEMOD, ANT2} communicates to an audience collector component AUD1 or AUD2, or to a plurality of audience collector components, the stream pieces of information emitted to the terminals 1.

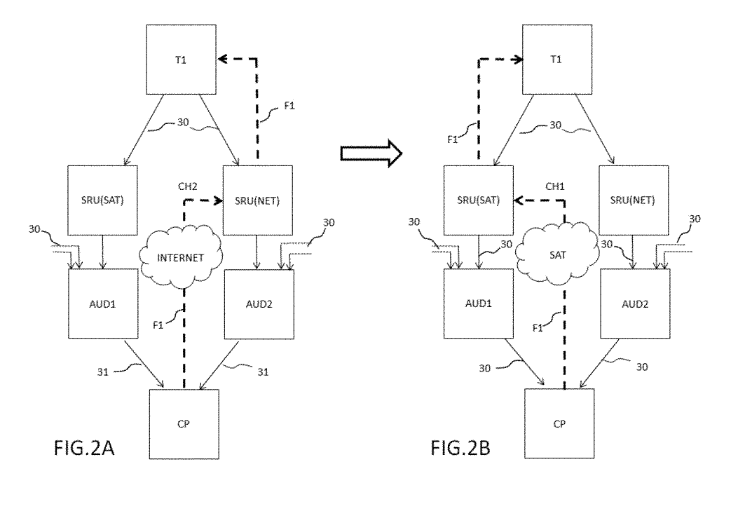

FIGS. 2A and 2B illustrate one embodiment of the method of the invention when a decision of switching from the second broadcasting channel CH₂ to the first broadcasting channel CH₁ is carried out depending on an audience threshold being exceeded.

FIG. 2A illustrates an exemplary case in which a content source PROV is represented, delivering a first stream F1 to a user reception system SRU(NET) through the second broadcasting channel CH₂, which is in this example a broadcasting channel established within the Internet network 2. The user reception system SRU(NET) is dedicated to a connection via the Internet network, it corresponds to the case of the user reception system 4 of FIG. 1. It can comprise for example an ADSL box.

The data connections 30 represent the audience data which will be retransmitted to the audience collector components AUD1, AUD2. According to other examples, as previously indicated, a single audience collector component AUD could have been represented. In the latter case, the audience collector component AUD can be configured in the network so as to be accessible from the Internet network and from the back path of the satellite SAT.

Some arrows 30 are represented coming from other sets of user terminals. The audience data 30 coming from other user reception systems SRU are indicated at the input of the audience collector components AUD1 and AUD2.

Data connections 31 indicate that a decision of the audience collector components AUD1 and AUD2 has been generated to a piloting component CP to establish a new broadcast strategy of the first stream F1 after the audience data have been analysed. According to another embodiment, the audience collector components AUD1 and AUD2 transmit the audience data to the content provider PROV which establishes itself the diffusion strategy to assume as a function of the results of both performed audience surveys.

In this example, when many users wish to view the first data stream F1 and that the latter is emitted on the second broadcasting channel CH₂ via the Internet network 2, a decision of changing the broadcasting channel CH₁, CH₂ of the first data stream F1 can be committed, for example by the piloting component.

The piloting component CP can activate broadcasting of a stream or inhibit it or change encoding. Further, the piloting component can act on a set of users having a second user reception system connected to the Internet network. For example, according to one embodiment, when the audience data of a stream are lower than a given threshold, the piloting component CP is configured to select a first set of users having only one user reception system connected to the Internet to hold the stream broadcasting by the second broadcasting channel CH₂. Further, the piloting component CP can select a second set of users that do not receive the stream any longer by the second broadcasting channel CH₂ but only by the first satellite broadcasting channel CH₁.

According to one embodiment, making the decision about changing the broadcasting channel CH₁, CH₂ can be automatically generated when the audience exceeds a first predefined threshold or when it is below a second predefined threshold.

FIG. 2B illustrates this configuration change in which the first broadcasting channel CH₁ passing through the satellite SAT is chosen to broadcast the first data stream F1.

The reception systems SRU(SAT) then relay the reception of the first data stream F1 and the first data stream F1 is no longer emitted through the Internet network 2, except for users which have no access to the satellite network.

The terminal 1 is thereby capable of automatically switching reading the expected stream from the broadcasting channel CH₂ to the broadcasting channel CH₁.

According to another embodiment, switching the broadcasting channel CH₁, CH₂ is programmed as a function of a time slot and/or a day of the week for example by a piloting component CP. Switching the broadcasting channel can also be programmed depending on point events such as broadcasting a football match the audience of which can be foreseen to exceed some threshold.

Thus, a given stream at a given moment can be preferentially broadcast by a satellite broadcasting channel so as to decrease the pass band of the Internet network and of the numerous multimedia streams passing through the network to each terminal. The terrestrial broadcasting will go on only for users which have no satellite access.

When a broadcasting channel is switched, the user reception systems taking the conveyance relay of a given stream in charge can be configured such that switching is made without information losses. The piloting component CP can be configured such that the stream is temporarily emitted on both broadcasting channels CH₁, CH₂ before suspending one of both emissions after switching.

### Stream Management of the First Broadcasting Channel CH₁

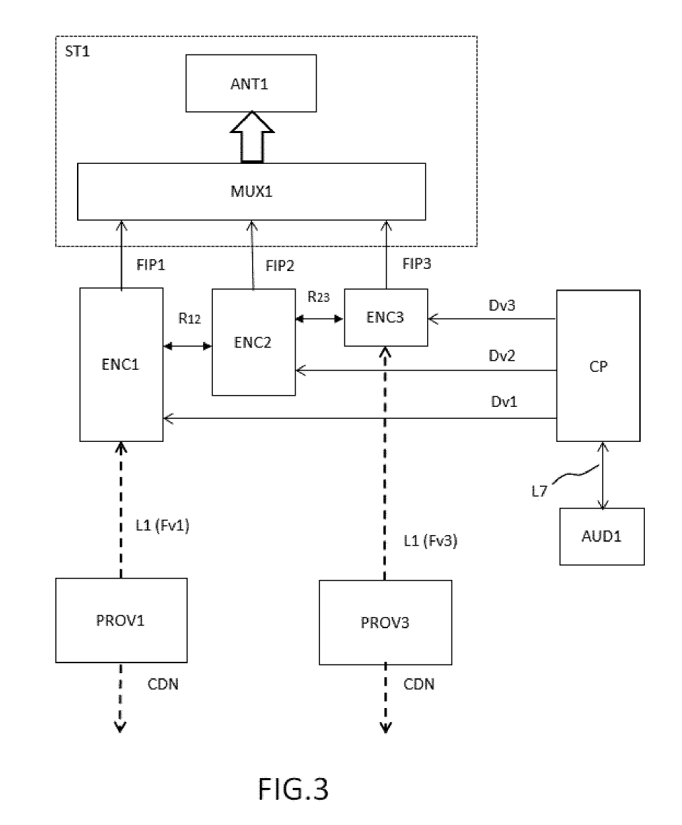

FIG. 3 represents one embodiment in which the different interfaces between the content provider PROV and the emitting antenna ANT1 to the satellite SAT are represented.

A multiplexer MUX1 enables different multimedia streams or others FIP1, FIP2, FIP3 to be multiplexed in an uplink signal emitted by the antenna ANT1 towards the satellite SAT.

The multiplexer MUX1 is configured to optimise the pass band of the signal emitted with a plurality of streams that can come from different content providers PROV1, PROV2, etc.

According to one embodiment, encoders ENC1, ENC2, ENC3 are configured to encode for example video streams Fv1, Fv2, Fv3 in frames IP, noted FIP1, FIP2, FIP3. The connections between the content providers and the encoders are designated by the connection L1 in FIG. 3.

### Piloting Component CP

A piloting component CP enables the audience data collected by the audience collector components AU1, AUD2 to be taken into consideration. The piloting component CP can be associated with a content provider PROV or it can be offset at the emitter ANT2 to supervise the streams emitted in the uplink signals to the satellite.

According to one embodiment, a piloting system comprises several piloting components CP of which:
a first piloting component CP1 supervises the allocation of the multimedia streams in the RF signal emitted to the satellite SAT;
a second piloting component CP supervises the generation of the streams in a point-to-point manner through the Internet network 2.

Different configurations can be considered depending on the method of the invention such that a same stream allocation policy in the broadcasting channels CH₁, CH₂ is applied in an identical way in accordance with rules generated from the audience data collected.

According to one embodiment, a piloting component CP generates instructions to the encoders so as to prioritise some emitted streams, inhibit them or encode them with a predefined compression rate. The instructions are directly generated from the collected audience data.

According to an exemplary embodiment, depending on the audience data recovered by at least one audience collector component AUD1 and/or AUD2, the piloting component CP, via the interface L7, can generate a compression index enabling a media stream to be more or less compressed. If a stream has a low audience, a strong compression can be applied to gain in pass band on the signal emitted to the satellite SAT to emit another stream, or improve the quality of a stream which is very much in demand.

The piloting component CP is capable of combining streams from different content providers in different encoders so as to optimise the emission bandwidth of the signal emitted to the satellite SAT.

The functions provided by the piloting component CP include in particular:
collecting all the audience data by the audience collector components AUD1, AUD2 or synthesis data of the audience collectors generated to the piloting component CP;
computing metrics or establishing prioritisation rules aiming at establishing a multimedia stream broadcast strategy in the different broadcasting channels CH₁, CH₂;
calculating a transmission cost of a stream as a function of the broadcasting channel: unicast or multipoint broadcast and of a given audience;
calculating a compression rate of some streams broadcast in the first broadcasting channel CH₁ as a function of a given audience and a total capacity of available pass band;
determining a route or a path to the second broadcasting channel for broadcasting a multimedia route to a user reception system;
generating orders to pieces of equipment of the Internet network 2 such as IP routers or servers of CDN data to distribute a given stream to a given user reception system;
emitting signalling data to at least one user reception system to indicate the source of the multimedia stream which has been chosen according to an assignment rule as a function of the collected audience data;
repeating one of the previous steps periodically so as to automotise the method according to the invention and make automatic the generation of an allocation policy.

When a decision by the piloting component CP is made while aiming at broadcasting a given stream via the first broadcasting channel CH₁ via a satellite connection because the audience data reveal that a great number of users is viewing said stream, the piloting component CP can also determine:
the number and identity of users wishing to view the stream in question having no satellite connection, so as to generate a set of point-to-point streams in the Internet network 2 towards this sub-set of users.

This option enables the users having no satellite connection to be able to continue to benefit from an overall offer of the available streams.

One advantage of this solution is to reduce the occupied pass band of the Internet network 2 by limiting broadcasting of a stream on the second broadcasting channel CH₂ only to a some number of users having no user reception system receiving the stream from a satellite.

1. A method for optimising an allocation of broadcasting channels of at least a first multimedia data stream delivered by at least a first data source, wherein a piloting component pilots the allocation of a broadcasting channel among at least:
a first broadcasting channel delivering a first data stream by a satellite broadcasting system to at least a first user reception system, said at least first user reception system comprising a first transmission system of the first data stream to at least a first user terminal,
a second broadcasting channel delivering the first data stream by a terrestrial data network to at least a second user reception system, said at least second user reception system comprising a second transmission system of the first data stream to at least the first user terminal,
said method comprising:
determining an allocation parameter comprising calculating an audience value of at least one number of first data streams delivered to a first set of terminals by at least one broadcasting channel, said calculation being performed by at least one audience collector component, said at least one audience collector component collecting audience data of a second set of terminals of the first set of terminals by a back link between at least the first user reception system and a terrestrial base station passing through at least one satellite, said first user reception system comprising an antenna for emitting a signal to a satellite, and
selecting at least one broadcasting channel by the piloting component as a function of the allocation parameter for broadcasting at least the first data stream to at least the first user terminal.

2. The optimising method according to claim 1, wherein the audience collector component comprises a data server connected to the terrestrial data network and collects audience data of a third set of terminals of the first set of terminals by a terrestrial back link.

3. The optimising method according to claim 3, wherein each terminal of the second set and the third set of terminals receives the first data stream by the first transmission system or the second transmission system means.

4. The optimising method according to claim 3, wherein the audience collector component centralises the audience data of the second and third sets of terminals.

5. The optimising method according to claim 1, wherein the piloting component comprises a first configuration enabling at least one event to be defined at a given date and having a predefined duration during which the allocation parameter is modified so as to select a predefined broadcasting channel, to at least the first user terminal for transmitting a data stream.

6. The optimising method according to claim 1, wherein the piloting component comprises a second configuration enabling a set of time slots of the calendar during which the allocation parameter is modified to be defined so as to select a predefined broadcasting channel to at least the first user terminal for transmitting a data stream.

7. The optimising method according to claim 1, wherein at least one given terminal generates an instruction for selecting a single broadcasting channel when a first stream is accessible through both transmission channels, said instruction being transmitted to the first transmission system or to the second transmission system so as to end the transmission of the first stream to said at least one terminal.

8. The optimising method according to claim 7, wherein the first or second transmission system, receiving the selecting instruction, transmit said selecting instruction to the piloting component so as to carry out a selection of at least one broadcasting channel as a function of the selecting instruction to ensure a single broadcasting of at least the first data stream to at least the first user terminal.

9. The optimising method according to claim 1, wherein the first data source comprises the piloting component.

10. The optimising method according to claim 1, wherein the first data source and a second data source each deliver the first multimedia data stream to the first broadcasting channel and respectively to the second broadcasting channel, said selection of the first and the second broadcasting channel being carried out by a piloting component connected to said first and second data sources.

11. The optimising method according to claim 1, wherein a configuration of a width of a pass band of the first broadcasting channel is determined as a function of the allocation parameter.

12. The optimising method according to claim 1, wherein the satellite broadcasting system comprises at least one ground station comprising at least one antenna for emitting signals to the satellite, the piloting component allocating a set of data streams, to a plurality of encoding computers as a function of at least one allocation parameter, each encoding computer:
encoding the delivered streams selected by the piloting component in frames IP to a multiplexer;
allocating a compression quality to each data stream delivered as a function of at least one allocation parameter,
said ground station comprising a multiplexer delivering a set of data to be modulated and to be emitted by the antenna to the satellite.

13. The optimising method according to claim 13, wherein the satellite comprises a second multiplexer and a plurality of transponders each forming a transmission channel ensuring a given pass band, each data stream selected by the piloting component being automatically distributed in at least one transponder as a function of the allocation parameter.

14. The optimising method according to claim 12, wherein the piloting component further automatically determines the compression quality of the first data stream as a function of the allocation parameter.

15. The optimising method according to claim 1, wherein the first user reception system comprises:
an antenna for receiving a signal of a first frequency band;
a signal amplifier for amplifying the received signal;
a component enabling the received signal to be transposed in a second frequency band;
a modem enabling a received or emitted signal to be modulated and demodulated;
a signal converter enabling a digital data stream to be delivered.

16. The optimising method according to claim 16, wherein the first user reception system further comprises:
an antenna for emitting a signal of a third frequency band to a satellite.

17. The optimising method according to claim 1, wherein:
the terrestrial data network comprises a CDN network for broadcasting multimedia content;
the second user reception system comprises a modem using an ADSL or fibre technology connected to the data network;
the second transmission system comprise a WIFI interface.

18. The optimising method according to claim 1, wherein:
the multimedia content comprises a video stream and/or an audio and/or data stream;
the multimedia content is delivered in a continuous stream ensuring viewing on the user terminal continuously;
frames conveying the multimedia content in the first and/or the second broadcasting channel are IP frames.

19. The optimising method according to claim 1, wherein the user terminal is:
a smartphone and/or;
a touch tablet and/or;
a pc;
a television set.

20. A user terminal enabling viewing of a multimedia content, comprising:
a first interface for receiving data from a first transmission system delivering a first data stream passing beforehand through a satellite and broadcast to a set of terminals;
a second interface for receiving data from a second transmission system delivering the first data stream passing through a terrestrial network, upon request from one of the terminals, said terminal comprising a computer configured to:
determine an availability of the first stream on both interfaces;
to generate a selecting instruction to the second transmission system to end the transmission of the first stream to the user terminal;
to select the first interface to receive the first data stream.
